(19) United States
(12) Patent Application Publication
(10) Pub. No.: US 2016/0190850 A1
(43) Pub. Date: Jun. 30, 2016

(54) ENHANCED WIRELESS CHARGING THROUGH ACTIVE COOLING

(71) Applicant: Intel Corporation, Santa Clara, CA (US)

(72) Inventors: NITHYANANDA S. JEGANATHAN, Portland, OR (US); JAMES W. EDWARDS, Hillsboro, OR (US); DARIA A. LOI, Portland, OR (US); DON J. NGUYEN, Portland, OR (US)

(73) Assignee: Intel Corporation, Santa Clara, CA (US)

(21) Appl. No.: 14/583,052

(22) Filed: Dec. 24, 2014

(51) Int. Cl. H02J 7/02; H02J 7/00

(52) U.S. Cl. CPC H02J 7/025; H02J 7/0044

(57) ABSTRACT

Methods and apparatus relating to enhanced wireless charging through active cooling are described. An embodiment integrates wireless charging with active cooling functionality to improve wireless charging efficiency, as well as overall system performance by mitigating thermal energy transfer between a charging pad and a mobile computing device. Other embodiments are also disclosed and claimed.

### FIELD

The present disclosure generally relates to the field of electronics. More particularly, an embodiment relates to techniques for enhanced wireless charging through active cooling.

### BACKGROUND

Inductive wireless charging pads are emerging as promising technology to replace traditional wired chargers for portable computing devices. The wireless transmission of electromagnetic waves from the charging pad to the computing device produces thermal energy on the charging coils on both the pad and the computing device. More particularly, due to the physical contact of the computing device with the wireless pad, the thermal energy generated in the pad is transferred to the computing device, leading to increased skin temperature.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 shows a block diagram of a wireless charging system with active cooling, according to an embodiment.

FIG. 2 illustrates a flow diagram of a method to be performed at a portable computing device and a charging pad, according to an embodiment.

FIGS. 3A, 3B, 4A, 4B, 4C, and 4D illustrate various views of a charging pad, according to some embodiments.

FIGS. 5-8 illustrate block diagrams of embodiments of computing systems, which may be utilized to implement various embodiments discussed herein.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

As discussed above, inductive wireless charging pads are emerging as promising technology to replace traditional wired chargers for portable computing devices. The wireless transmission of electromagnetic waves from the charging pad to the computing device produces thermal energy on the charging coils on both the pad and the computing device. More particularly, due to the physical contact of the computing device with the wireless pad, the thermal energy generated in the pad is transferred to the computing device, leading to increased skin temperature (Tskin).

Tskin increase negatively impacts system performance and its effect is more pronounced on convertible (e.g., 2:1) system usage in slate mode. As a result, in certain high performance usages, wireless charging may have to be turned off to reduce the net thermal energy in the platform. These limitations reduce the effectiveness of wireless charging technology to power the 2:1 platforms. To counter this, wireless charging pads may reduce the transmitting power of the antenna to mitigate the heat that will be generated on the coils. Consequently, wireless charging efficiency decreases and it takes much longer to charge a portable computing device than it would have been otherwise.

Some embodiments provide techniques for enhanced wireless charging through active cooling. An embodiment integrates wireless charging with active cooling functionality to improve wireless charging efficiency, as well as overall system performance by mitigating thermal energy transfer between a charging pad and a mobile computing device (e.g., a 2:1 system in the slate mode/configuration).

As discussed herein, a “2:1” computing device generally refers to a portable (also referred to herein interchangeably as “mobile”) computing device that includes a tablet portion (which may include one or more of: a System On Chip (SOC), a flat panel display device (such as an Liquid Crystal Display (LCD)), battery pack(s), charging antenna(s), etc.) and a base or keyboard portion (that may include one or more of: an SOC, one or more battery pack(s), storage device(s), charging antenna(s), etc.). In some implementations, the base or keyboard portion may provide a mechanism for inputting data (such as one or more of: a keyboard, a mouse, a touchpad, etc.). Also, a 2:1 mobile computing device may include two modes of use or configurations: first, a tablet mode, where the tablet portion is used as a table computing device; and second, a slate mode, where the tablet portion and the base/keyboard portions are coupled.

Generally, active cooling is a technique in which a computing system is cooled continuously through a mechanism such as one or more cooling fans. As active cooling constantly transfers the heat that is generated within the system scope into the environment, optimum thermal limits may be maintained for sustained periods of operation.

Some embodiments strategically place and position an active cooling mechanism, namely fans, on a wireless charging pad to achieve one or more of the following: (a) increase the transmitting power of the coils to reduce the time taken to charge the system; and (b) reduce impact on system performance by lowering the thermal transfer from the charging pad to the base of a portable computing device. By contrast, current wireless charging pads generally do not use active cooling to prevent or reduce heat transfer from the pad to the device. Moreover, by simultaneously cooling both the pad and the computing device, a wireless pad with active cooling will deliver the best user experience on platforms by: (1) rapidly charging the mobile device and enabling more widespread adoption of wireless charging mats/pads; and (2) keeping the device and charging pad cool while enabling the best performance under all modes of operation.

Further, active cooling mechanisms discussed herein enable a computing system to stay cool under different workloads, leading to better overall performance. By integrating the aforementioned two elements into a single computing system, the best overall user experience and performance can be provided.

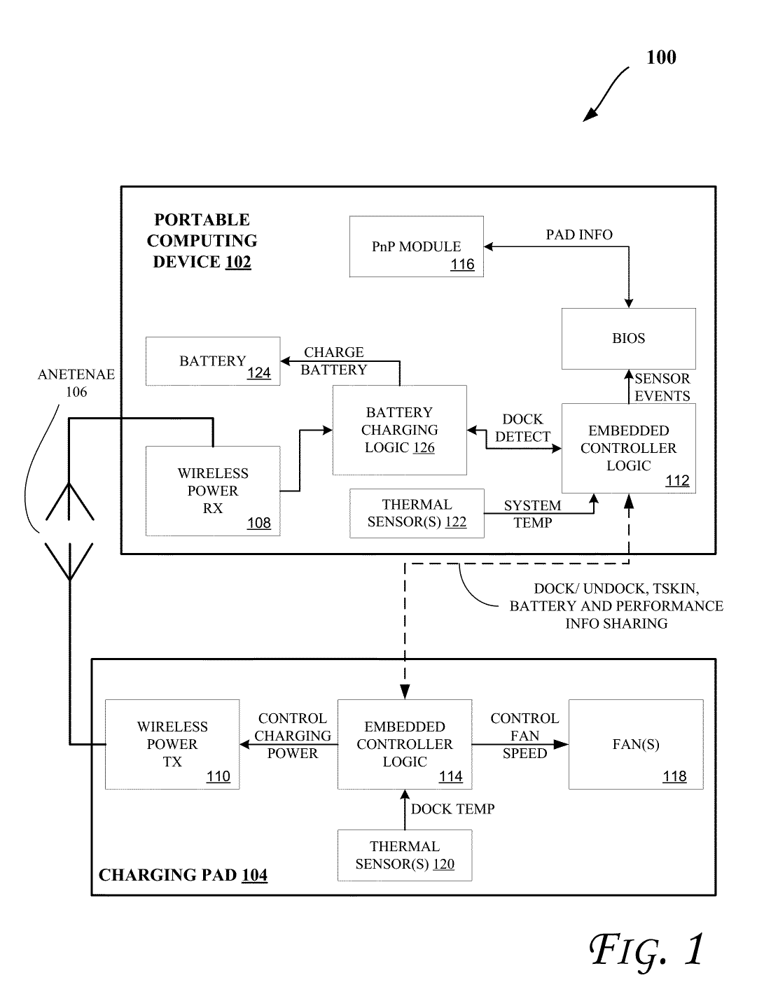

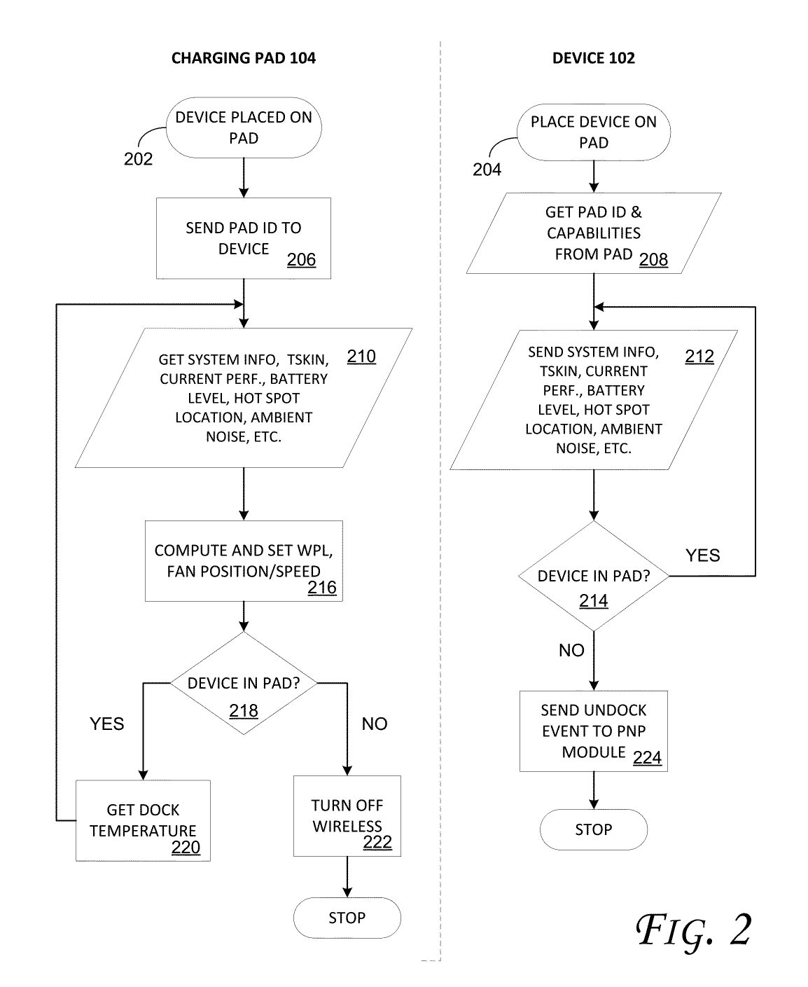

FIG. 1 shows a block diagram of a computing system with Wireless charging with Active cooling (WcAc), according to an embodiment. FIG. 2 illustrates a flow diagram of a method 200 to be performed at a portable computing device and a charging pad, according to an embodiment. For example, method 200 may be performed at device 102 and charging pad 104 of FIG. 1. In some embodiments, one or more operations discussed with reference to method 200 are performed by logic (e.g., EC 112 or EC 114). For example, one or more of operations on the right side of FIG. 2 (e.g., performed at device 102) may be performed by EC 112, whereas one or more operation on the left side of FIG. 2 (e.g., performed at the charging pad 104) may be performed by EC 114.

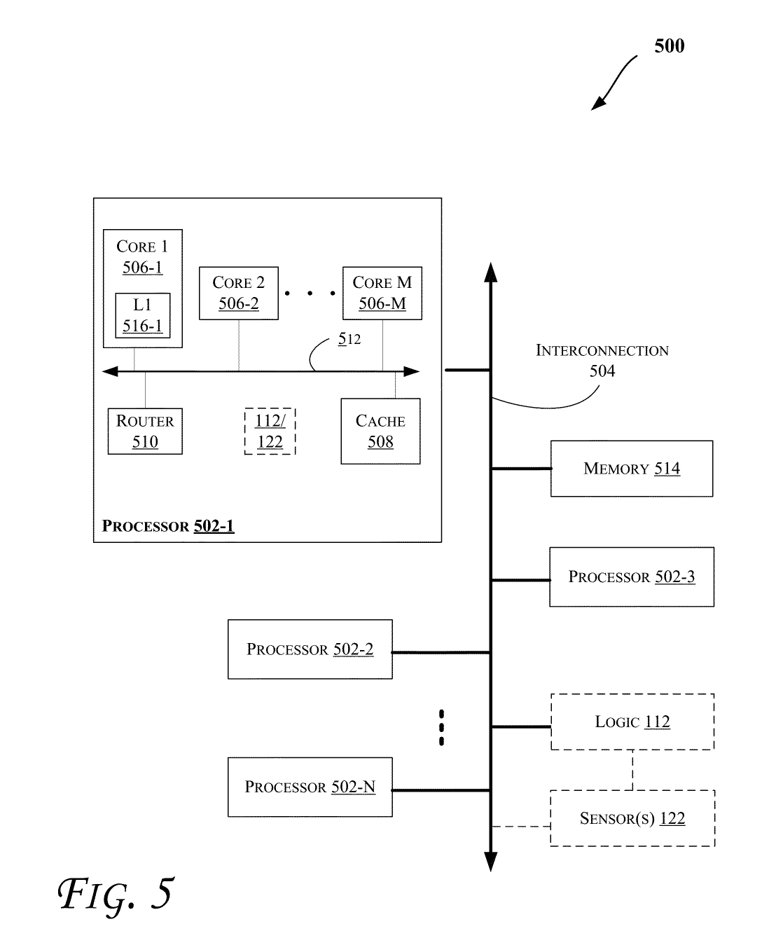

Referring to FIG. 1, system 100 includes a portable computing device 102 and a charging pad 104. Antennae 106 (e.g., at least one for each device 102 and pad 104) enable wireless transmission of electromagnetic waves from the charging pad 104 to the computing device 102 to allow for wireless charging. In an embodiment, portable computing device 102 includes a mobile computing devices such as a smartphone, tablet, UMPC (Ultra-Mobile Personal Computer), laptop computer, Ultrabook™ computing device, wearable devices (such as smart watch, smart glasses, smart bracelets, and the like (such as those discussed with reference to FIGS. 5-8).

Portable computing device 102 includes a wireless power receiver (RX) 108 to receive electromagnetic waves (through one of antennae 106 directly coupled to the RX 108) and charging pad 104 includes a wireless power transmitter (TX) 110 to transmit the electromagnetic waves (through one of antennae 106 directly coupled to TX).

Referring to FIGS. 1-2, when device 102 is first placed on the pad 104 (at operation(s) 202/204), an Embedded Controller (EC) or logic 112 detects the presence of the charging pad by communicating (at operation(s) 206/208) with pad EC or logic 114 and negotiates a protocol for transfer of system information to the charging pad (at operation(s) 210/212). After the pad detection completion (at operation(s) 214/216), EC 112 may optionally exchange/pass pad and/or system state change information to a Performance and Power (PnP) handling module 116 (e.g., at operation 212). The PnP module may observe that the system is currently operating with WcAc pad and may increase the performance levels of the device 102. In an embodiment, PnP module 116 may operate in accordance with software instruction(s) (or otherwise implemented in software), whereas the rest of the items shown in FIG. 1 in connection with device 102 may be controlled via firmware.

EC 114 is responsible for detecting and communicating dock/undock events, for example, when a tablet/2:1 system is placed on the pad for wireless charging or removed from the pad. EC 114 coordinates with EC 112 to detect system presence and negotiates peripheral communication protocol using available interconnects, such as those discussed with reference to FIGS. 5-8 (including for example Universal Serial Bus(USB), Interface to Communicate (I2C), Bluetooth (BT), etc.). In an embodiment, EC 114 is responsible for making three decisions: adjust the Wireless Power Levels (WPL) for transmitter 110; (2) control the speed of one or more fans 118 (coupled or provided in the charging pad as will be further discussed herein with reference to the remaining figures); and (3) react to local hotspot(s) (e.g., as detected based on input from one or more thermal sensors 120) by increasing/decreasing speed of fans 118.

Furthermore, the WPL of transmitter 110 may be set as a function of Tskin of device 102, current battery level of device 102, temperature of the dock (housing the pad 104), and the current system performance level (e.g., at operation 216). The value of Tskin of device 102 and dock/pad temperature may be expressed in degrees Celsius, Fahrenheit, Kelvin, etc.; the battery level may be expressed in Watt Hours or mAH (or milli-Ampere Hours); and the system performance level may be expressed by a relative numerical value.

For example, as the Tskin level rises (e.g., based on temperature value(s) detected by one or more sensors 122), EC 114 lowers the WPL generated by transmitter 110. If device 102 is already running hot (e.g., based on temperature value(s) detected by sensor(s) 122), then increasing the charging level may increase undesirable heat in the system. So, WPL of transmitter may not be increased until the Tskin of the device 102 drops below a certain threshold value (e.g., Tₜₕ).

Also, as the current level of one or more battery packs 124 increases (e.g., as determined/detected by battery charging logic 126), EC 114 lowers the WPL of transmitter 110. If the battery level is greater that some threshold level (e.g., BL_{Th}), then charging slowly will not have a major user impact, so EC 114 may reduce the WPL of transmitter 110, e.g., to lower undesirable heat generation.

Further, as the temperature of the pad/dock increases, EC 114 lowers the WPL of transmitter 110. If the pad is running hotter than normal limits (or some threshold temperature value as detected by sensor(s) 120), then there is a higher chance of conducting thermal energy to the device 102. So, if the current battery level is above some threshold level (e.g., BL_{Th}), then EC 114 lowers the WPL of transmitter 110.

Additionally, as the performance level of device 102 increases, EC 114 increases the WPL of transmitter 110. For instance, if device 102 is currently running at higher utilization workloads, then battery levels may drain quickly and hence there would be a need to charge the battery faster. Lower utilization may not indicate lower WPL but higher utilization may indirectly require higher WPL to be able to charge the battery faster.

In some embodiments, the position and/or speed of fan(s) 118 may also be adjusted (e.g., as determined by operation 216). For example, fan position and/or speed may be a function of device 102 temperature (e.g., based on temperature value(s) detected by sensor(s) 122), pad 104 temperature (e.g., based on temperature value(s) detected by sensor(s) 120), any detected local hotspot(s) (e.g., based on temperature value(s) detected by sensor(s) 120 and/or 122), and/or ambient noise (e.g., as detected by one or more microphones (not shown) proximate to the device 102 and/or pad 104 (or, for example, embedded in a dock that houses the pad 104).

Hence, as the temperature of device 102 increases, EC 114 increases the speed of fan(s) 118. In other words, if the device 102 is currently running very hot, then pad fan speeds will have to be increased to reduce the overall temperature of the system. Also, as the pad temperature rises, EC 114 increases the speed of fans 118. If the WcAc is running at higher temperature than normal (or some threshold value), then fan speed needs to be increased to take the additional heat away from the pad. Further, the closer a fan is to a hotspot, the higher its speed needs to be. For example, EC 112 notifies EC 114 regarding the local hotspot location in the system. WcAc may respond by increasing fan speeds in specific locations to cool the hotspot(s) on the device 102. For instance, if the system is running hot (e.g., based on comparison with a threshold value) at lower middle portion of the device, then fan(s) closest to that spot will be run at higher speeds to cool that specific portion of the device 102.

As for ambient noise, higher ambient noise levels can generally allow for higher fan speeds. In an embodiment, the noise level(s) are measured in decibels. For example, if the ambient noise surrounding the charging pad is relatively high (e.g., based on a comparison with a threshold value), then the user may not be able to hear the fan noise running at higher decibels. So, fans may be run at higher speeds without impacting user experience in the presence of higher ambient noise levels.

As shown in FIG. 2, once the device and pad are coupled or engaged (at operation 218), the dock/pad temperature is obtained at operation 220. Once the device is undocked (e.g., as determined by operation(s) 214/218), method 200 terminates after turning off the wireless charging (e.g., at operation 222) and sending undock even to PnP Module 116 (at operation 224).

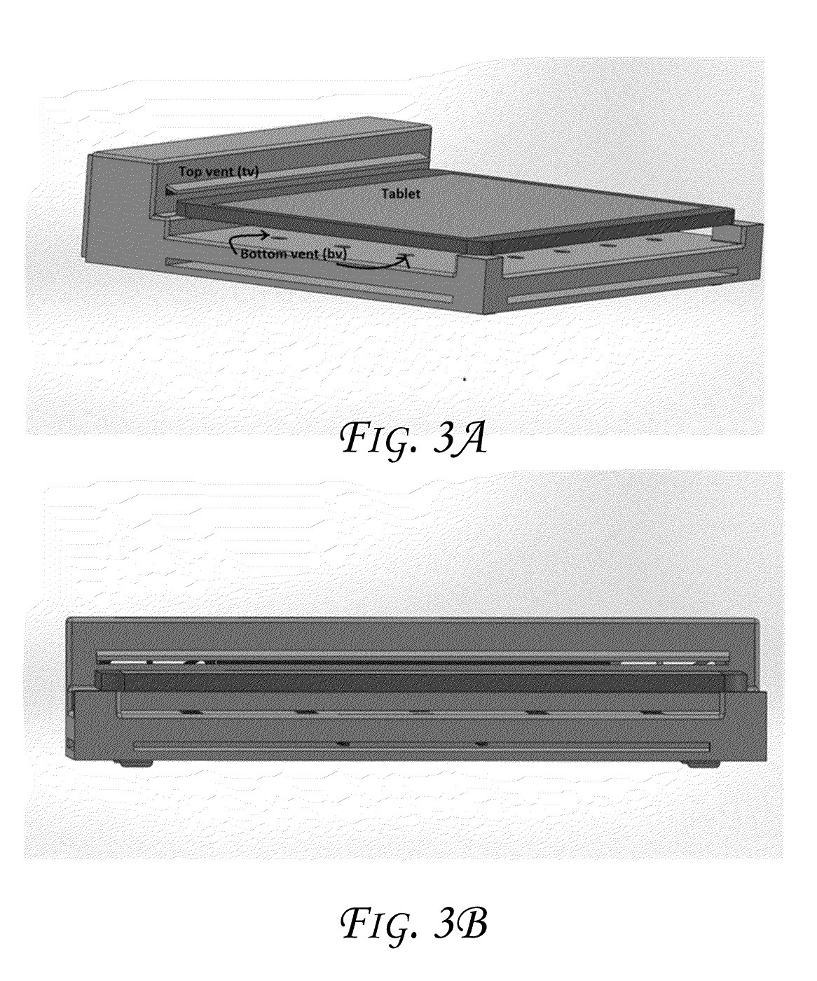

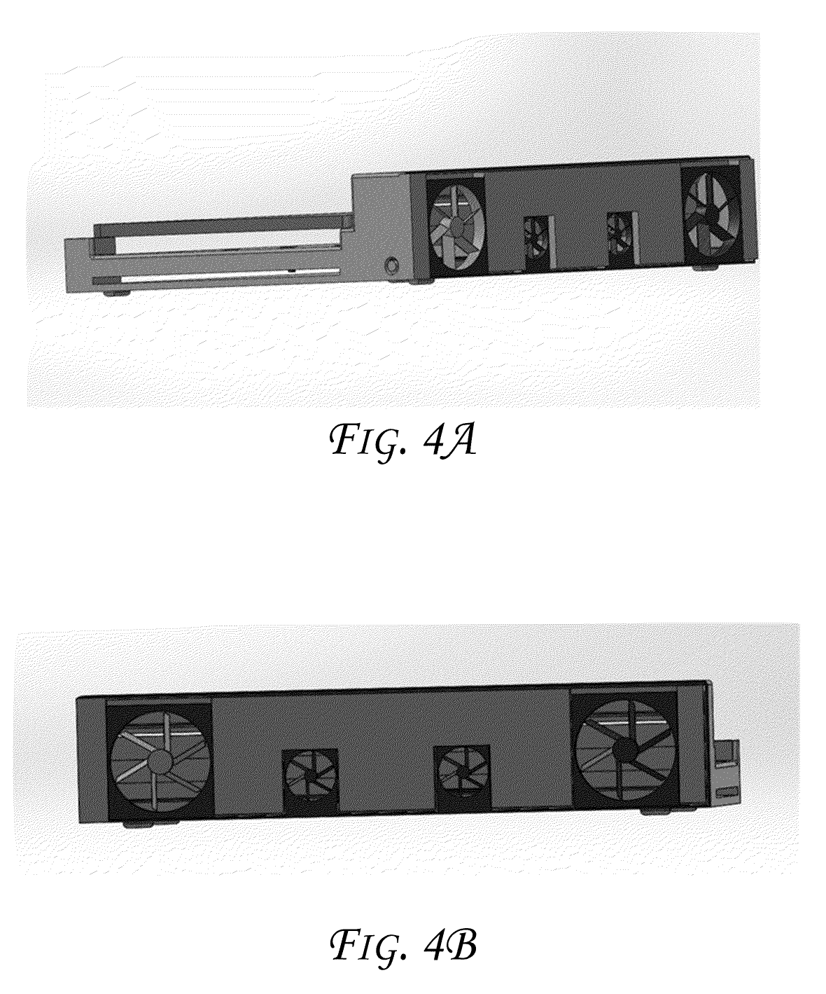

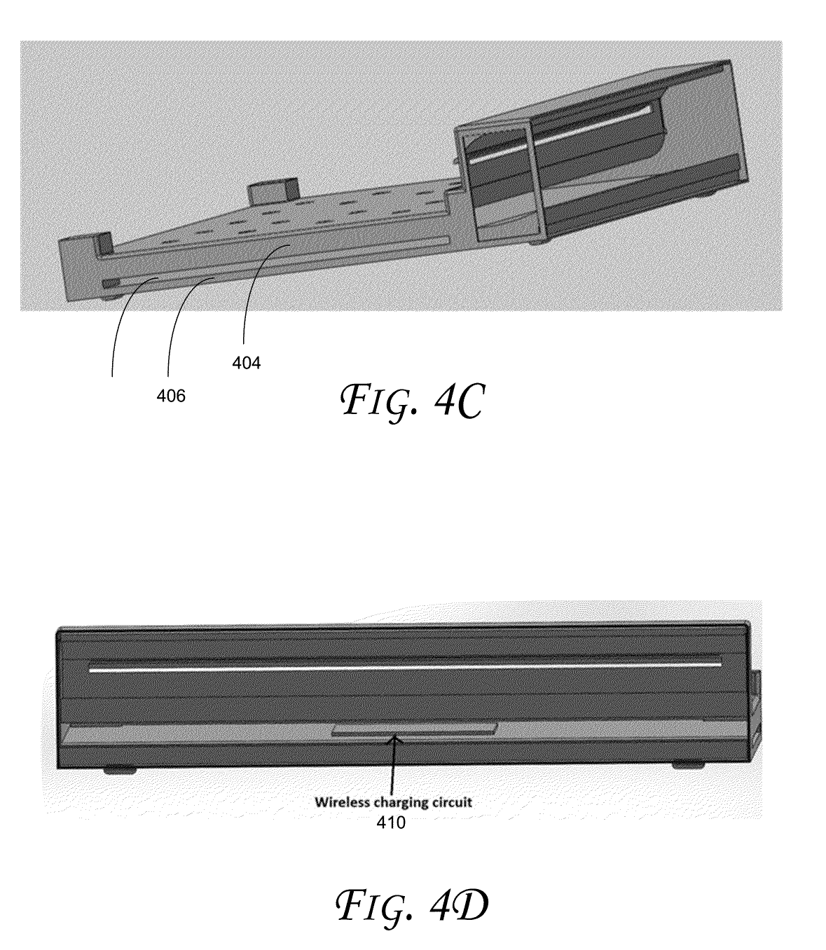

Example of a wireless charging pad with active cooling (or WcAc) is shown in the following figures, according to some embodiments. Other embodiments may have the entire setup to be adjustable to become vertical as well. In such a mode, the user can continue to use the 2:1 as a tablet/external display while it is actively being charged by the pad. FIG. 3A shows a perspective via of a tablet placed on a charging pad with active cooling, according to an embodiment. The air gap between the tablet and pad is only for illustration purposes, e.g., as gap of less than about 1 millimeter may be left between the tablet and the pad in some embodiments. Air circulation is achieved through placement of fan(s) in the pad and air is blown on the top of the system through a top vent (tv) and bottom of the system through a bottom vent (bv). Fan placements are shown in FIGS. 4A-4B. Air flow from the fans will flow through the tv and by through the guiding channels.

FIG. 3B shows a front view of the wireless charging pad with active cooling, and a tablet engaged or coupled to the pad, according to an embodiment. FIG. 4A illustrates a side view of the pad with the tablet and sample fans, according to an embodiment. FIG. 4B illustrates a back view of a charging pad with sample fans, according to an embodiment. FIG. 4C shows a side view of the WcAc without the fans and tablet, according to an embodiment. The hollow region 402 between the top layer 404 and bottom layer 406 acts as a conduit for air to raise to the cooling level for the tablet placed above bottom vents (bv).

FIG. 4D illustrates a back view of the pad with charging circuit placement, according to an embodiment. In an embodiment, the wireless charging circuit 410 (e.g., including transmitter 110) is placed directly below the location of receiver antenna in the tablet. When the tablet is placed on the WcAc, the wireless charging circuit 410 charges the tablet battery (e.g., battery 124) with power, e.g., to enable the tablet to run performance intensive workloads.

Some embodiments may be applied in computing systems that include one or more processors (e.g., with one or more processor cores), such as those discussed with reference to FIGS. 5-8, including for example mobile computing devices such as a smartphone, tablet, UMPC (Ultra-Mobile Personal Computer), laptop computer, Ultrabook™ computing device, wearable devices (such as smart watch, smart glasses, smart bracelets, and the like), etc. More particularly, FIG. 5 illustrates a block diagram of a computing system 500, according to an embodiment. The system 500 may include one or more processors 502-1 through 502-N (generally referred to herein as “processors 502” or “processor 502”).

The processors 502 may be general-purpose CPUs (Central Processing Units) and/or GPUs (Graphics Processing Units) in various embodiments. The processors 502 may communicate via an interconnection or bus 504. Each processor may include various components some of which are only discussed with reference to processor 502-1 for clarity. Accordingly, each of the remaining processors 502-2 through 502-N may include the same or similar components discussed with reference to the processor 502-1.

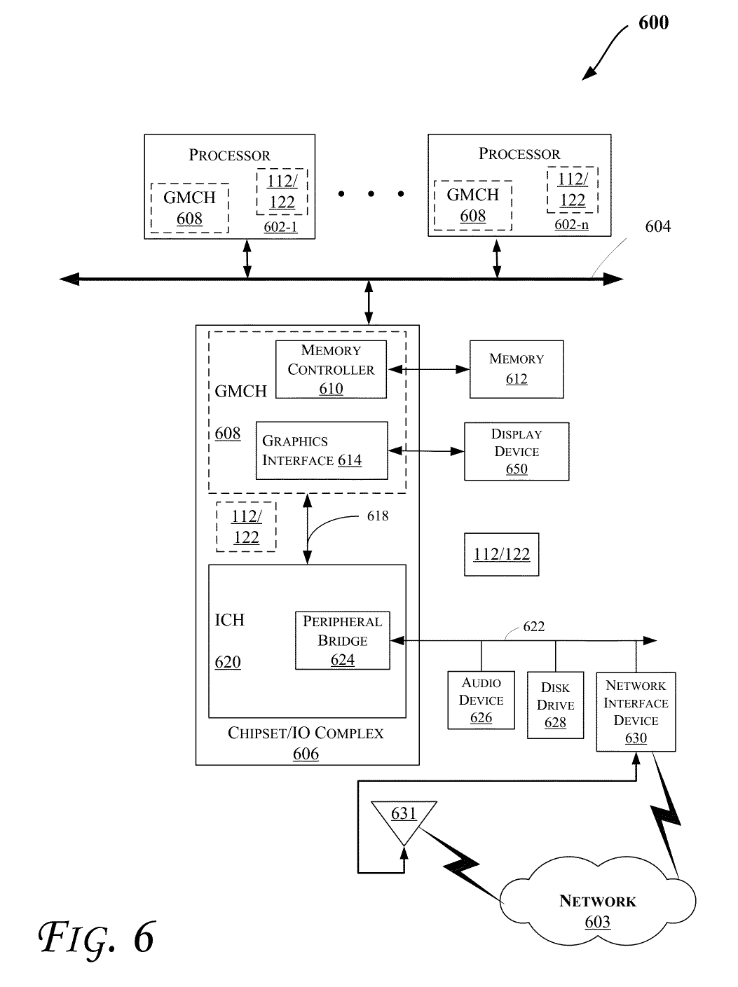

In an embodiment, the processor 502-1 may include one or more processor cores 506-1 through 506-M (referred to herein as “cores 506,” or “core 506”), a cache 508, and/or a router 510. The processor cores 506 may be implemented on a single integrated circuit (IC) chip. Moreover, the chip may include one or more shared and/or private caches (such as cache 508), buses or interconnections (such as a bus or interconnection 512), graphics and/or memory controllers (such as those discussed with reference to FIGS. 6-8), or other components.

In one embodiment, the router 510 may be used to communicate between various components of the processor 502-1 and/or system 500. Moreover, the processor 502-1 may include more than one router 510. Furthermore, the multitude of routers 510 may be in communication to enable data routing between various components inside or outside of the processor 502-1.

The cache 508 may store data (e.g., including instructions) that are utilized by one or more components of the processor 502-1, such as the cores 506. For example, the cache 508 may locally cache data stored in a memory 514 for faster access by the components of the processor 502 (e.g., faster access by cores 506). As shown in FIG. 5, the memory 514 may communicate with the processors 502 via the interconnection 504. In an embodiment, the cache 508 (that may be shared) may be a mid-level cache (MLC), a last level cache (LLC), etc. Also, each of the cores 506 may include a Level 1 (L1) cache (516-1) (generally referred to herein as “L1 cache 516”) or other levels of cache such as a Level 2 (L2) cache. Moreover, various components of the processor 502-1 may communicate with the cache 508 directly, through a bus (e.g., the bus 512), and/or a memory controller or hub.

As shown, system 500 may also include sensor(s) 122 to facilitate thermal and/or performance management as discussed herein. For example, sensor(s) 122 may be provided proximate to components of system 500, including, for example, the cores 506, interconnections 504 or 512, components outside of the processor 502 (like a voltage regulator and/or power source (not shown)), etc., to sense variations in various factors effecting power/thermal behavior of the system/platform, such as temperature, operating frequency, operating voltage, power consumption, and/or inter-core communication activity, etc. In an embodiment, at least one sensor 122 may be coupled to a dock (e.g., charging pad 104 discussed with reference to FIGS. 1-4D) to detect when the mobile computing device 100 is docked or otherwise attached to the dock. System 500 also includes logic 112 to control thermal behavior and/or performance of (e.g., heat generating) components of system 500 (such as processors 502, memory 514, etc.) and cause an adjustment or modification to the thermal behavior and/or performance of such components, e.g., based on information received from the sensor(s) 122 as discussed herein.

While some optional locations of logic 112 and sensors 122 are shown in FIGS. 5-8, these locations are for illustrative purposes only and items 122/112 may be located elsewhere in these computing systems and embodiments are not limited to the locations shown in these figures. For example, in an embodiment, one or more sensors 122 may be located physically/thermally proximate to the back skin of a tablet or portable computing device (and/or proximate to hot spot(s)) discussed with reference to the previous figures.

FIG. 6 illustrates a block diagram of a computing system 600 in accordance with an embodiment. The computing system 600 may include one or more Central Processing Units (CPUs) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)).

Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an embodiment, one or more of the processors 602 may be the same or similar to the processors 502 of FIG. 5. Further, one or more components of system 600 may include logic 112 coupled to the sensor(s) 122, discussed with reference to FIGS. 1-5 (including but not limited to those locations illustrated in FIG. 6). Also, the operations discussed with reference to FIGS. 1-5 may be performed by one or more components of the system 600.

A chipset 606 may also communicate with the interconnection network 604. The chipset 606 may include a graphics memory control hub (GMCH) 608, which may be located in various components of system 600 (such as those shown in FIG. 6). The GMCH 608 may include a memory controller 610 that communicates with a memory 612 (which may be the same or similar to the memory 514 of FIG. 5). The memory 612 may store data, including sequences of instructions, that may be executed by the CPU 602, or any other device included in the computing system 600. In one embodiment, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The GMCH 608 may also include a graphics interface 614 that communicates with the display device. In one embodiment, the graphics interface 614 may communicate with a display device via an accelerated graphics port (AGP) or Peripheral Component Interconnect (PCI) (or PCI express (PCIe) interface). In an embodiment, the display (such as a flat panel display) may communicate with the graphics interface 614 through, for example, a signal converter that translates a digital representation of an image stored in a storage device such as video memory or system memory into display signals that are interpreted and displayed by the display device. The display signals produced by the display device may pass through various control devices before being interpreted by and subsequently displayed on the display device.

A hub interface 618 may allow the GMCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. As shown, the network interface device 630 may be coupled to an antenna 631 to wirelessly (e.g., via an Institute of Electrical and Electronics Engineers (IEEE) 802.11 interface (including IEEE 802.11a/b/g/n/ac, etc.), cellular interface, 3G, 5G, LPE, etc.) communicate with the network 603. Other devices may communicate via the bus 622. Also, various components (such as the network interface device 630) may communicate with the GMCH 608. In addition, the processor 602 and the GMCH 608 may be combined to form a single chip. Furthermore, a graphics accelerator may be included within the GMCH 608 in other embodiments.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

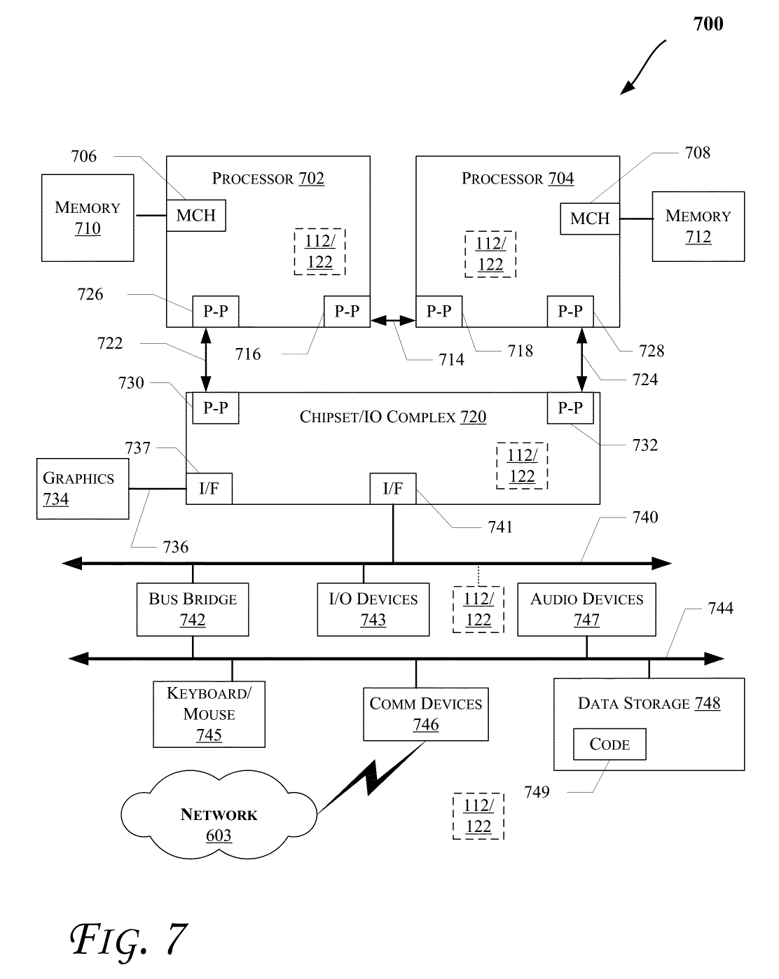

FIG. 7 illustrates a computing system 700 that is arranged in a point-to-point (PtP) configuration, according to an embodiment. In particular, FIG. 7 shows a system where processors, memory, and input/output devices are interconnected by a number of point-to-point interfaces. The operations discussed with reference to FIGS. 1-6 may be performed by one or more components of the system 700.

As illustrated in FIG. 7, the system 700 may include several processors, of which only two, processors 702 and 704 are shown for clarity. The processors 702 and 704 may each include a local memory controller hub (MCH) 706 and 708 to enable communication with memories 710 and 712. The memories 710 and/or 712 may store various data such as those discussed with reference to the memory 612 of FIG. 6.

In an embodiment, the processors 702 and 704 may be one of the processors 602 discussed with reference to FIG. 6. The processors 702 and 704 may exchange data via a point-to-point (PtP) interface 714 using PtP interface circuits 716 and 718, respectively. Also, the processors 702 and 704 may each exchange data with a chipset 720 via individual PtP interfaces 722 and 724 using point-to-point interface circuits 726, 728, 730, and 732. The chipset 720 may further exchange data with a graphics circuit 734 via a graphics interface 736, e.g., using a PtP interface circuit 737.

At least one embodiment may be provided within the processors 702 and 704. Further, one or more components of system 700 may include logic 112 coupled to the sensor(s) 122, discussed with reference to FIGS. 1-6 (including but not limited to those locations illustrated in FIG. 7). Other embodiments, however, may exist in other circuits, logic units, or devices within the system 700 of FIG. 7. Furthermore, other embodiments may be distributed throughout several circuits, logic units, or devices illustrated in FIG. 7.

The chipset 720 may communicate with a bus 740 using a PtP interface circuit 741. The bus 740 may communicate with one or more devices, such as a bus bridge 742 and I/O devices 743. Via a bus 744, the bus bridge 742 may communicate with other devices such as a keyboard/mouse 745, communication devices 746 (such as modems, network interface devices, or other communication devices that may communicate with the computer network 603), audio I/O device 747, and/or a data storage device 748. The data storage device 748 may store code 749 that may be executed by the processors 702 and/or 704.

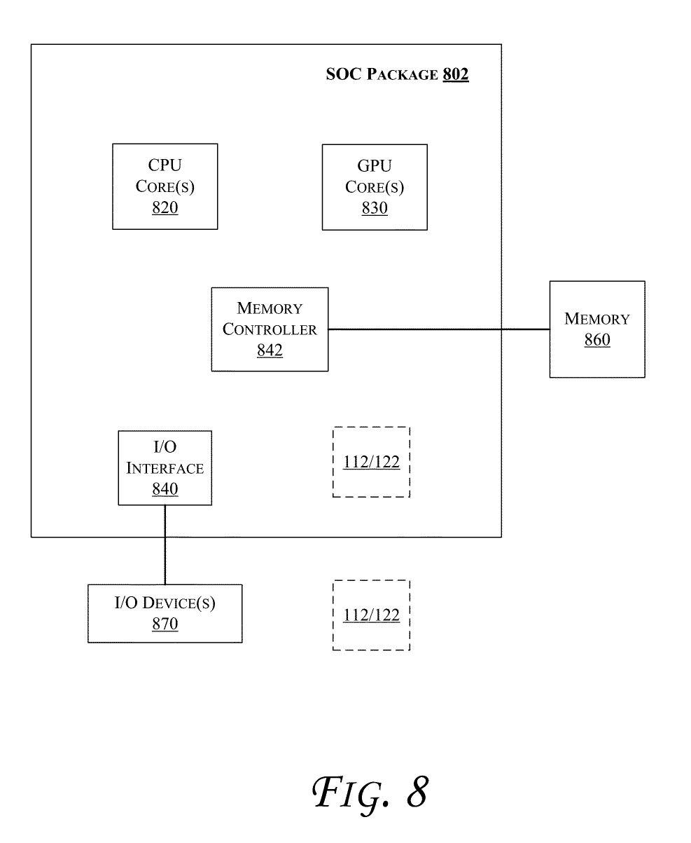

In some embodiments, one or more of the components discussed herein can be embodied as a System On Chip (SOC) device. FIG. 8 illustrates a block diagram of an SOC package in accordance with an embodiment. As illustrated in FIG. 8, SOC 802 includes one or more Central Processing Unit (CPU) cores 820, one or more Graphics Processing Unit (GPU) cores 830, an Input/Output (I/O) interface 840, and a memory controller 842. Various components of the SOC package 802 may be coupled to an interconnect or bus such as discussed herein with reference to the other figures. Also, the SOC package 802 may include more or less components, such as those discussed herein with reference to the other figures. Further, each component of the SOC package 820 may include one or more other components, e.g., as discussed with reference to the other figures herein. In one embodiment, SOC package 802 (and its components) is provided on one or more Integrated Circuit (IC) die, e.g., which are packaged into a single semiconductor device.

As illustrated in FIG. 8, SOC package 802 is coupled to a memory 860 (which may be similar to or the same as memory discussed herein with reference to the other figures) via the memory controller 842. In an embodiment, the memory 860 (or a portion of it) can be integrated on the SOC package 802.

The I/O interface 840 may be coupled to one or more I/O devices 870, e.g., via an interconnect and/or bus such as discussed herein with reference to other figures. I/O device(s) 870 may include one or more of a keyboard, a mouse, a touchpad, a display device, an image/video capture device (such as a camera or camcorder/video recorder), a touch screen, a speaker, or the like. Furthermore, SOC package 802 may include/integrate logic 112 and/or sensor(s) 122 in some embodiments. Alternatively, logic 112 and/or sensor(s) 122 may be provided outside of the SOC package 802 (i.e., logic 112 is provided as a discrete logic). Also, in an embodiment, one or more of the sensors 122 may be (thermally) coupled to the back skin of a portable computing device that includes the SOC package 802 and/or proximate to the one or more hotspots discussed with reference to the previous figures.

Moreover, the scenes, images, or frames discussed herein (e.g., which may be processed by the graphics logic in various embodiments) may be captured by an image capture device (such as a digital camera (that may be embedded in another device such as a smart phone, a tablet, a laptop, a stand-alone camera, etc.) or an analog device whose captured images are subsequently converted to digital form). Moreover, the image capture device may be capable of capturing multiple frames in an embodiment. Further, one or more of the frames in the scene are designed/generated on a computer in some embodiments. Also, one or more of the frames of the scene may be presented via a display (such as the display discussed with reference to FIGS. 6 and/or 7, including for example a flat panel display device, etc.).

The following examples pertain to further embodiments. Example 1 includes an apparatus comprising: logic, the logic at least partially comprising hardware logic, to cause modification to a wireless power level of a wireless charging transmitter based at least in part on one or more temperature values, wherein the one or more temperature values are to be detected by one or more sensors that are to be proximate to one or more components of a portable computing device. Example 2 includes the apparatus of example 1, wherein the portable computing device is to comprise the logic. Example 3 includes the apparatus of example 1, wherein the logic is to cause modification to the wireless power level of the wireless charging transmitter based at least in part on an indication that the portable computing device is coupled to a wireless charging pad that is to comprise the wireless charging transmitter. Example 4 includes the apparatus of example 1, comprising logic to cause modification to speed of one or more fans, coupled to a wireless charging pad, based at least in part on one or more of: a docking status of the portable computing device, the one or more temperature values, ambient noise, a current performance level of the portable computing device, one or more hotspots, a battery charge level, and one or more wireless charging pad temperature values to be detected by one or more wireless charging pad sensors that are to be proximate to one or more components of a wireless charging pad. Example 5 includes the apparatus of example 1, further comprising one or more antennae to receive electromagnetic waves from the wireless charging transmitter. Example 6 includes the apparatus of example 1, wherein a wireless charging pad is to comprise the wireless charging transmitter. Example 7 includes the apparatus of example 1, wherein the portable computing device is to comprise one or more of: a System On Chip (SOC) device; a processor, having one or more processor cores; a flat panel display device, and memory. Example 8 includes the apparatus of example 1, wherein the portable computing device is to comprise one of: a smartphone, a tablet, a phablet, a UMPC (Ultra-Mobile Personal Computer), a laptop computer, an Ultrabook™ computing device, and a wearable device. Example 9 includes the apparatus of example 1, wherein one or more of the logic, a processor having one or more processor cores, the one or more sensors, and memory are on a single integrated circuit die.

Example 10 includes an apparatus comprising: logic, the logic at least partially comprising hardware logic, to cause a wireless charging pad to modify speed of one or more fans, coupled to the wireless charging pad, based at least in part on a docking status of a portable computing device. Example 11 includes the apparatus of example 10, wherein the portable computing device is to comprise the logic. Example 12 includes the apparatus of example 10, wherein the logic is to cause modification to a wireless power level of a wireless charging transmitter of the wireless charging pad based at least in part on one or more temperature values, wherein the one or more temperature values are to be detected by one or more sensors that are to be proximate to one or more components of the portable computing device. Example 13 includes the apparatus of example 10, wherein the logic to cause modification to the speed of the one or more fans based at least in part on one or more of: ambient noise, a current performance level of the portable computing device, one or more hotspots, a battery charge level, and one or more temperature values to be detected by one or more sensors that are to be proximate to one or more components of the portable computing device. Example 14 includes the apparatus of example 10, further comprising one or more antennae to receive electromagnetic waves from a wireless charging transmitter of the wireless charging pad. Example 15 includes the apparatus of example 10, wherein the portable computing device is to comprise one or more of: a System On Chip (SOC) device; a processor, having one or more processor cores; a flat panel display device, and memory. Example 16 includes the apparatus of example 10, wherein the portable computing device is to comprise one of: a smartphone, a tablet, a phablet, a UMPC (Ultra-Mobile Personal Computer), a laptop computer, an Ultrabook™ computing device, and a wearable device. Example 17 includes the apparatus of example 10, wherein one or more of the logic, a processor having one or more processor cores, one or more sensors, and memory are on a single integrated circuit die.

Example 18 includes an apparatus comprising: logic, the logic at least partially comprising hardware logic, to cause modification to a wireless power level of a wireless charging transmitter based at least in part on one or more temperature values, wherein the one or more temperature values are to be detected by one or more sensors that are to be proximate to one or more components of a wireless charging pad. Example 19 includes the apparatus of example 18, wherein the wireless charging pad is to comprise the logic. Example 20 includes the apparatus of example 18, wherein the logic is to cause modification to the wireless power level of the wireless charging transmitter based at least in part on an indication that a portable computing device is coupled to the wireless charging pad. Example 21 includes the apparatus of example 18, comprising logic to cause modification to speed of one or more fans, coupled to the wireless charging pad, based at least in part on one or more of: a docking status of a portable computing device, the one or more temperature values, ambient noise, a current performance level of the portable computing device, one or more hotspots, a battery charge level, and one or more device temperature values to be detected by one or more device sensors that are to be proximate to one or more components of the portable computing device. Example 22 includes the apparatus of example 18, further comprising one or more antennae to transmit electromagnetic waves from the wireless charging transmitter.

Example 23 includes an apparatus comprising: logic, the logic at least partially comprising hardware logic, to cause modification to speed of one or more fans, coupled to a wireless charging pad, based at least in part on a docking status of a portable computing device. Example 24 includes the apparatus of example 23, wherein the wireless charging pad is to comprise the logic. Example 25 includes the apparatus of example 23, wherein the logic is to cause modification to a wireless power level of a wireless charging transmitter of the wireless charging pad based at least in part on one or more temperature values, wherein the one or more temperature values are to be detected by one or more sensors that are to be proximate to one or more components of the portable computing device or one or more components of the wireless charging pad.

Example 26 includes a method comprising: causing modification to a wireless power level of a wireless charging transmitter based at least in part on one or more temperature values, wherein the one or more temperature values are detected by one or more sensors that are to be proximate to one or more components of a portable computing device. Example 27 includes the method of example 26, wherein causing the modification is performed by the portable computing device. Example 28 includes the method of example 26, wherein causing modification to the wireless power level of the wireless charging transmitter is performed based at least in part on an indication that the portable computing device is coupled to a wireless charging pad that comprises the wireless charging transmitter.

Example 29 includes a method comprising: causing a wireless charging pad to modify speed of one or more fans, coupled to the wireless charging pad, based at least in part on a docking status of a portable computing device. Example 30 includes the method of example 29, wherein causing the wireless charging pad to modify speed of the one or more fans is performed by the portable computing device. Example 31 includes the method of example 29, wherein causing modification to the wireless power level of the wireless charging transmitter of the wireless charging pad is performed based at least in part on one or more temperature values, wherein the one or more temperature values are detected by one or more sensors that are proximate to one or more components of the portable computing device.

Example 32 includes a method comprising: causing modification to a wireless power level of a wireless charging transmitter based at least in part on one or more temperature values, wherein the one or more temperature values are detected by one or more sensors that are proximate to one or more components of a wireless charging pad. Example 33 includes the method of example 32, wherein causing the modification is performed by the wireless charging pad. Example 34 includes the method of example 32, wherein causing the modification to the wireless power level of the wireless charging transmitter is performed based at least in part on an indication that a portable computing device is coupled to the wireless charging pad.

Example 35 includes a method comprising: causing modification to speed of one or more fans, coupled to a wireless charging pad, based at least in part on a docking status of a portable computing device. Example 36 includes the method of example 35, wherein causing the modification is performed by the wireless charging pad. Example 37 includes the method of example 35, wherein causing the modification to the wireless power level of the wireless charging transmitter of the wireless charging pad is performed based at least in part on one or more temperature values, wherein the one or more temperature values are detected by one or more sensors that are proximate to one or more components of the portable computing device or one or more components of the wireless charging pad.

Example 38 includes an apparatus comprising means to perform a method as set forth in any preceding example.

Example 39 comprises machine-readable storage including machine-readable instructions, when executed, to implement a method or realize an apparatus as set forth in any preceding example.

In various embodiments, the operations discussed herein, e.g., with reference to FIGS. 1-8, may be implemented as hardware (e.g., logic circuitry), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIGS. 1-8.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
logic, the logic at least partially comprising hardware logic, to cause modification to a wireless power level of a wireless charging transmitter based at least in part on one or more temperature values,
wherein the one or more temperature values are to be detected by one or more sensors that are to be proximate to one or more components of a portable computing device.

2. The apparatus of claim 1, wherein the portable computing device is to comprise the logic.

3. The apparatus of claim 1, wherein the logic is to cause modification to the wireless power level of the wireless charging transmitter based at least in part on an indication that the portable computing device is coupled to a wireless charging pad that is to comprise the wireless charging transmitter.

4. The apparatus of claim 1, comprising logic to cause modification to speed of one or more fans, coupled to a wireless charging pad, based at least in part on one or more of: a docking status of the portable computing device, the one or more temperature values, ambient noise, a current performance level of the portable computing device, one or more hotspots, a battery charge level, and one or more wireless charging pad temperature values to be detected by one or more wireless charging pad sensors that are to be proximate to one or more components of a wireless charging pad.

5. The apparatus of claim 1, further comprising one or more antennae to receive electromagnetic waves from the wireless charging transmitter.

6. The apparatus of claim 1, wherein a wireless charging pad is to comprise the wireless charging transmitter.

7. The apparatus of claim 1, wherein the portable computing device is to comprise one or more of: a System On Chip (SOC) device; a processor, having one or more processor cores; a flat panel display device, and memory.

8. The apparatus of claim 1, wherein the portable computing device is to comprise one of: a smartphone, a tablet, a phablet, a UMPC (Ultra-Mobile Personal Computer), a laptop computer, an Ultrabook™ computing device, and a wearable device.

9. The apparatus of claim 1, wherein one or more of the logic, a processor having one or more processor cores, the one or more sensors, and memory are on a single integrated circuit die.

10. An apparatus comprising:
logic, the logic at least partially comprising hardware logic, to cause a wireless charging pad to modify speed of one or more fans, coupled to the wireless charging pad, based at least in part on a docking status of a portable computing device.

11. The apparatus of claim 10, wherein the portable computing device is to comprise the logic.

12. The apparatus of claim 10, wherein the logic is to cause modification to a wireless power level of a wireless charging transmitter of the wireless charging pad based at least in part on one or more temperature values, wherein the one or more temperature values are to be detected by one or more sensors that are to be proximate to one or more components of the portable computing device.

13. The apparatus of claim 10, wherein the logic to cause modification to the speed of the one or more fans based at least in part on one or more of: ambient noise, a current performance level of the portable computing device, one or more hotspots, a battery charge level, and one or more temperature values to be detected by one or more sensors that are to be proximate to one or more components of the portable computing device.

14. The apparatus of claim 10, further comprising one or more antennae to receive electromagnetic waves from a wireless charging transmitter of the wireless charging pad.

15. The apparatus of claim 10, wherein the portable computing device is to comprise one or more of: a System On Chip (SOC) device; a processor, having one or more processor cores; a flat panel display device, and memory.

16. The apparatus of claim 10, wherein the portable computing device is to comprise one of: a smartphone, a tablet, a phablet, a UMPC (Ultra-Mobile Personal Computer), a laptop computer, an Ultrabook™ computing device, and a wearable device.

17. The apparatus of claim 10, wherein one or more of the logic, a processor having one or more processor cores, one or more sensors, and memory are on a single integrated circuit die.

18. An apparatus comprising:
logic, the logic at least partially comprising hardware logic, to cause modification to a wireless power level of a wireless charging transmitter based at least in part on one or more temperature values,
wherein the one or more temperature values are to be detected by one or more sensors that are to be proximate to one or more components of a wireless charging pad.

19. The apparatus of claim 18, wherein the wireless charging pad is to comprise the logic.

20. The apparatus of claim 18, wherein the logic is to cause modification to the wireless power level of the wireless charging transmitter based at least in part on an indication that a portable computing device is coupled to the wireless charging pad.

21. The apparatus of claim 18, comprising logic to cause modification to speed of one or more fans, coupled to the wireless charging pad, based at least in part on one or more of:
a docking status of a portable computing device, the one or more temperature values, ambient noise, a current performance level of the portable computing device, one or more hotspots, a battery charge level, and one or more device temperature values to be detected by one or more device sensors that are to be proximate to one or more components of the portable computing device.

22. The apparatus of claim 18, further comprising one or more antennae to transmit electromagnetic waves from the wireless charging transmitter.

23. An apparatus comprising:
logic, the logic at least partially comprising hardware logic, to cause modification to speed of one or more fans, coupled to a wireless charging pad, based at least in part on a docking status of a portable computing device.

24. The apparatus of claim 23, wherein the wireless charging pad is to comprise the logic.

25. The apparatus of claim 23, wherein the logic is to cause modification to a wireless power level of a wireless charging transmitter of the wireless charging pad based at least in part on one or more temperature values, wherein the one or more temperature values are to be detected by one or more sensors that are to be proximate to one or more components of the portable computing device or one or more components of the wireless charging pad.
